(19) United States
(12) Patent Application Publication
(10) Pub. No.: US 2002/0123925 A1
(43) Pub. Date: Sep. 5, 2002

(54) Method and system for automatically monitoring and rewarding the performance of support personnel in a remote service center

(75) Inventor: Gordon James Smith, Rochester, MN (US)

Correspondence Address: Andrew J. Dillon, BRACEWELL & PATTERSON, LLP, Lakewood on the Park, Suite 350, 7600B North Capital of Texas Highway, Austin, TX, 78731, US

(73) Assignee: International Business Machines Corporation

(21) Appl. No.: 09/796,883

(22) Filed: Mar. 1, 2001

(51) Int. Cl. G06F 17/60

(52) U.S. Cl. 705/14

(57) ABSTRACT

A business method and system for rewarding call center agents utilizes an automated call distribution system that receives calls from a public telephone system and distributes the incoming calls to the agents. The automated call distribution system monitors the performance of the agents via automated survey questions to the callers. The survey results are then combined with other data regarding sales and the number of calls handled by the agents to provide an agent incentive system. The incentive system also compares the performance of the agents for individual or group assessment. This information can be conveyed as text, graphs, images, audio, and/or video, and may be compared with other call centers as well.

### BACKGROUND OF THE INVENTION

1. Technical Field

This invention relates in general to rewarding support personnel, and in particular to a method and system for electronically monitoring and rewarding support personnel. Even more particularly, the invention relates to a system and method for automatically monitoring and rewarding the performance of support personnel in a remote service center via electronic means.

2. Description of the Related Art

Many companies provide customer support services and/or technical support to their constituents. It is quite common for companies to remotely provide these services over the telephone or through a computer via the Internet. In order to enhance the efficiency of such services, some companies utilize centralized call centers wherein numerous service personnel are located to receive and respond to the requests. Call centers typically use a hierarchical call or inquiry distribution system to direct the requests to appropriate agents who are trained to handle such matters. The hierarchy of customer requests can be based on numerous variables including, for example, urgency and business value to the company.

In the prior art, some companies have provided personalized incentives for their service personnel in order to enhance the overall performance of their call centers. For example, in U.S. Pat. No. 6,049,779 (hereinafter, Berkson), a method of providing incentives to call center employees based on electronic monitoring is described. Berkson suggests an incentive method whereby service agents are given access to games in order to relieve the monotony between calls. In this prior art invention, the performance of the agents is based the length of a call, the number of calls, and, optionally, on-line or concurrent monitoring by a supervisor. While Berkson is an interesting approach to enhancing the performance of call center agents, it will not necessarily motivate all employees. For example, some older employees may not consider game access to be a significant performance incentive. Thus, an improved business method for motivating call center agents would be desirable.

### SUMMARY OF THE INVENTION

One embodiment of a business method and system for rewarding call center agents utilizes an automated call distribution system that receives calls from a public telephone system and distributes the incoming calls to the agents. The automated call distribution system monitors the performance of the agents via automated survey questions to the callers. The survey results are then combined with other data regarding sales and the number of calls handled by the agents to provide an agent incentive system. The incentive system also compares the performance of the agents for individual or group assessment. This information can be conveyed as text, graphs, images, audio, and/or video, and may be compared with other call centers as well.

For example, a voicing and response unit may prompt all callers with the same set of questions and collect the callers' responses to the questions. The questions are selected from a survey question database that can be modified based on an external input. The responses of the callers are gathered by the voicing and response unit and stored in a survey response database. The survey response database also provides the results of the survey questions to a summary and statistics unit, which is interconnected to the incentive system and a communications controller.

The foregoing and other objects and advantages of the present invention will be apparent to those skilled in the art, in view of the following detailed description of the preferred embodiment of the present invention, taken in conjunction with the appended claims and the accompanying drawings.

### BRIEF DESCRIPTION OF THE DRAWINGS

So that the manner in which the features, advantages and objects of the invention, as well as others which will become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only a preferred embodiment of the invention and are therefore not to be considered limiting of its scope as the invention may admit to other equally effective embodiments.

FIG. 1 depicts a schematic diagram of an illustrative embodiment of an automated interface constructed in accordance with the method and system of the present invention.

FIG. 2 is a layer diagram of programs in a data processing system of FIG. 1 that cooperate to automatically connect to a remote data processing system according to the method and system of the present invention.

FIG. 3 is a high level block diagram of an illustrative embodiment of the method and system of the present invention utilized by the automated interface of FIG. 1.

FIG. 4 is a block diagram of a performance monitoring system used in the system of FIG. 3.

FIG. 5 is a schematic diagram of one version of an information display generated by the performance monitoring system of FIG. 4.

FIG. 6 is a high level, logical flowchart of an illustrative embodiment of the method and system of the present invention.

### DETAILED DESCRIPTION OF THE PREFERRED EMBODIMENT

The present invention may be executed in a variety of systems including telephone systems and/or computer systems having various operating systems. The system may be a personal computer, a network computer, a midrange computer or a mainframe computer. In addition, the computer may be a stand-alone system or part of a network such as a local-area network (LAN) or a wide-area network (WAN). For the purposes of illustration, one embodiment of the present invention, as described below, is implemented utilizing a personal computer.

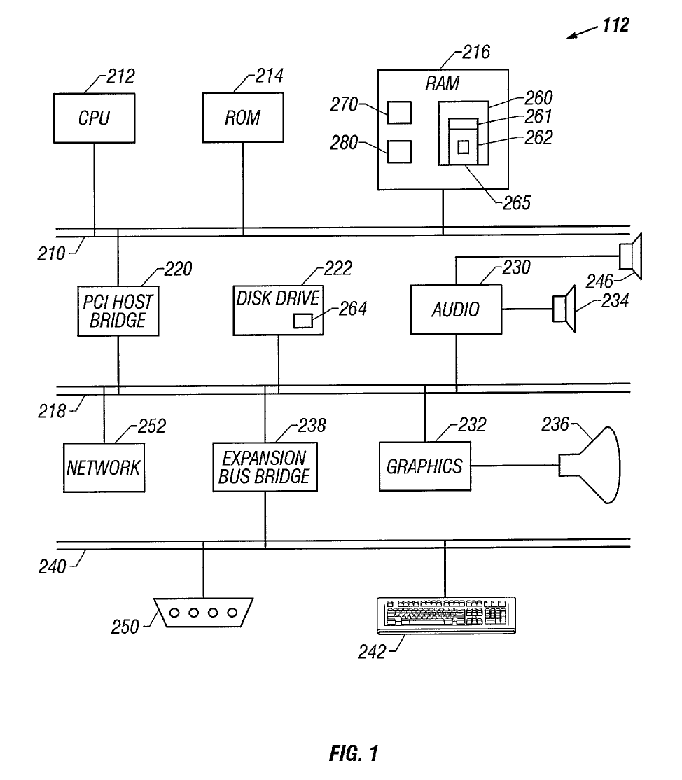

Referring now to FIG. 1, there is depicted a block diagram of a server 112. Server 112 includes a system bus 210 that is connected to a central processing unit (CPU) 212 and to memory, including read only memory (ROM) 214 and random access memory (RAM) 216. System bus 210 is coupled to a PCI local bus 218 through a PCI host bridge 220. PCI local bus 218 is connected to additional nonvolatile data storage devices, such as one or more disk drives 222, and to an audio adapter 230 and a graphics adapter 232 for controlling audio output through a speaker 234 and visual output through a display device 236, respectively. A PCI-to-ISA bus bridge, such as expansion bus bridge 238, connects PCI local bus 218 to an ISA bus 240, which is attached (through appropriate adapters) to a keypad 242 for receiving operator input. A microphone of other audio input device 246 is connected to audio adapter 230.

Also included within server 112 are data ports for communicating with external equipment, such as other data processing systems. The data ports include, without limitation, a serial port 250 attached to ISA bus 240 for linking server 112 to remote data processing systems (such as a bridge) via a modem (not illustrated) and a communications adapter 252 attached to PCI bus 218 for linking server 112 to other stations of a LAN (such as clients).

Server 112 also contains software applications that are stored on the data storage devices and loaded into RAM 216 for execution by CPU 212. Among those applications is a communications program, such as communications manager 260, that manages the exchange of information between the LAN and remote data processing systems. Included in communications manager 260 is a connection initiator 261 for establishing dial-up connections to remote data processing systems. Communications manager 260 also includes Internet sharing software 262 that enables multiple LAN stations to access the Internet via a single connection. In the illustrative embodiment, server 112 also includes a connection schedule file 264, which preferably is stored in disk drive 222, and Internet sharing software 262 includes a request predictor 265 that utilizes connection schedule file 264 to trigger connection initiator 261 in advance of anticipated communication requests.

Connection schedule file 264 is maintained by a schedule editor and/or an automatic schedule modifier, each of which is preferably also included in Internet sharing software 262. Server 112 also includes a Web browser 270 and an E-mail client 280 that allow an operator of server 112 or client to retrieve and view information from the Internet and send and receive E-mail via the Internet, respectively.

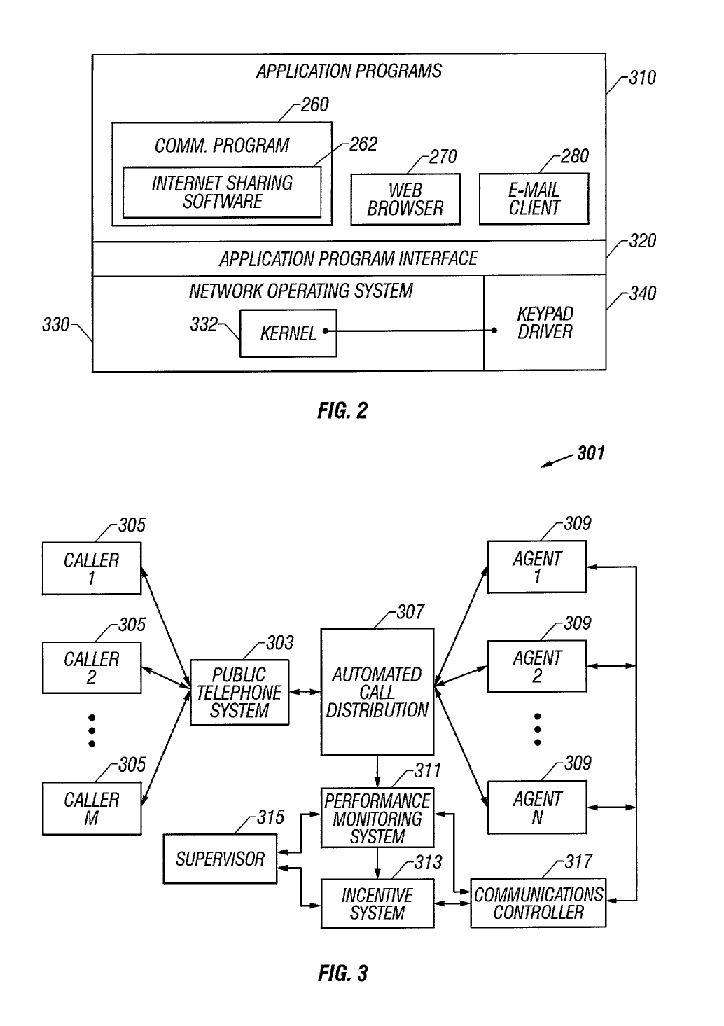

With reference now to FIG. 2, there is depicted a layer diagram of the software applications within server 112 that cooperate to provide the functionality of the present invention according to the illustrative embodiment. At the highest level of the layer diagram are the software application programs 310, including communications manager 260, web browser 270, and E-mail client 280. At the intermediate level is an application program interface (API) 320, through which application programs 310 request services from the operating system 330. Operating system 330, which occupies the lowest level of the layer diagram, is a network operating system. As such, in addition to managing the operations of server 112 (by performing duties such as resource allocation, task management, and error detection), operating system 330 also provides tools for managing communications within the LAN and between LAN stations and remote data processing systems. Included within operating system 330 is a kernel 332 that manages the memory, files, and peripheral devices of server 112. The lowest level also includes device drivers, such as a keypad driver 340 that kernel 332 utilizes to manage input from and output to peripheral devices.

Referring now to FIG. 3, one embodiment of the present invention is schematically illustrated as a call center system 301. Call center system 301 works in conjunction with a telephone system, such as a public telephone system 303, for delivering incoming telephone calls 305 from callers external to the call center such as customers, clients, and other constituents of the entity or company utilizing call center system 301. Note that FIG. 3 is merely illustrative of a telephone system embodiment of the present invention, and that other systems and combinations of systems having different constituent interactive means, such as a computer system with Internet-based communications (e.g., e-mail transmissions), also may be used and incorporated into the present invention.

An automated call distribution system 307 receives calls 305 from public telephone system 303 and distributes the incoming calls to one or more agents 309. The automated call distribution system 307 communicates with a performance monitoring system 311 to properly facilitate distribution of calls 305, as will be described in greater detail below. Performance monitoring system 311 utilizes stored programs to monitor the performance of agents 309. In addition, a program in performance monitoring system 311 provides automated survey questions to the callers, while other programs collect, tabulate, and analyze the results of the questions. Still another program in performance monitoring system 311 combines the survey results with other results including the number of calls handled by agents 309 per unit of time, the number of sales, etc., and provides one or more metrics to an incentive system 313.

Incentive system 313 utilizes stored programs that compare the performance of agents 309 (either on an absolute scale or on a curve). This information is made available either privately to a specific agent (if the agent is receiving a reward of some kind), or as an anonymous statistic that can be viewed by all agents 309 and/or supervisors 315. This service can be provided by performance monitoring system 311 or elsewhere within call center system 301. The calculated results and/or products of the analysis are presented to agents 309 via a communications controller 317. This information can be conveyed as text, graphs, images, audio, and/or video. For simplicity and ease of understanding, the information will be described in terms of graphical data. Over the course of a service period or work shift for each agent 309, data is accumulated and tabulated relating to the performance other and/or all agents 309. The other agents may be located within the same call center facility, a group of facilities such as those within a state or region (e.g., the United States), or around the world.

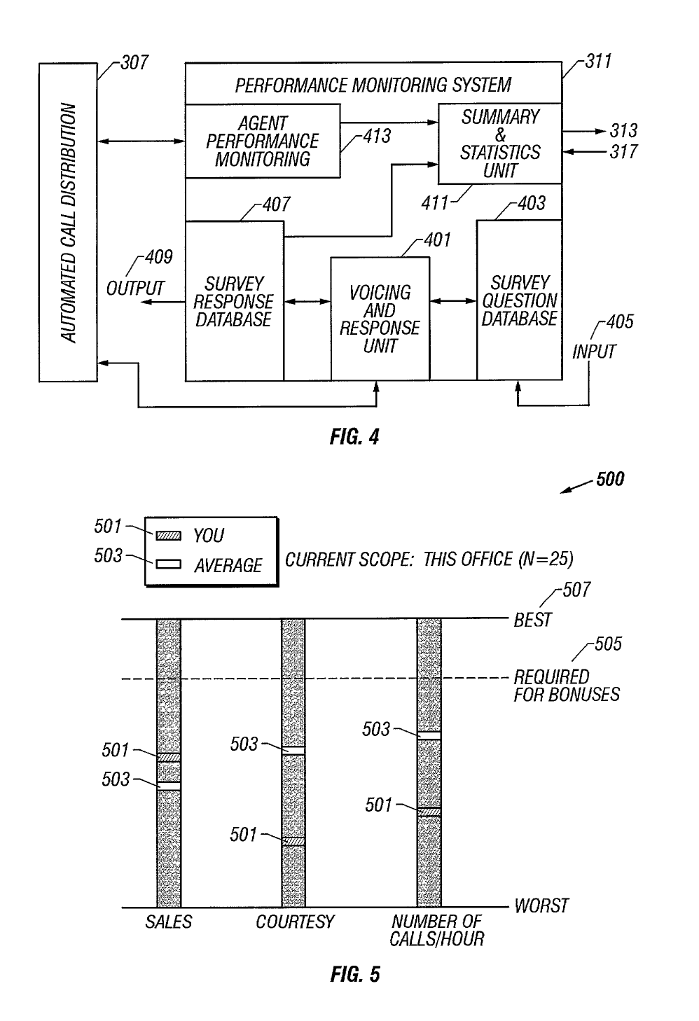

As stated above, the automated caller survey system administered by performance monitoring system 311 provides the necessary data. A more detailed block diagram of performance monitoring system 311 is provided in FIG. 4, including a voicing and response unit 401 that provides questions to callers via automated call distribution 307. For example, voicing and response unit 401 may prompt all callers with the same set of questions (independent of the agents providing the services) and collect the callers' responses to the questions. The questions are selected from a survey question database 403 that can be modified based on external input 405, such as a computer interface capable of editing the stored questions. A typical question stored in the database might be: “On a scale from one to ten with ten being the most satisfactory response, how well did the agent meet your requests? Please enter the number on your touch tone phone or say the number, now.”

The responses of the callers are gathered by voicing and response unit 401 and stored in a survey response database 407, which may be examined through an output 409. Output 409 may be a computer data port interface that is connected to another computer, such as a remotely located computer system. The survey response database 407 also provides the results of the survey questions to a summary and statistics unit 411. Summary and statistics unit 411 is interconnected to incentive system 313 and communications controller 317. An agent performance monitoring subsystem 413 provides another input to the summary and statistics unit 411. An agent performance monitoring subsystem 413 analyzes agent performance parameters including the number of calls handled by the agent per unit of time, the number of sales, etc.

The computer terminal at the desk of each agent 309 displays the performance information. Depending on the type of data that the agent wants to review, the information may be related to a current number of bonus points, additional vacation earned, retirement account supplements, stock options earned, or other personal data. An alternative example is shown as a chart 500 in FIG. 5, wherein the agent's performance 501 as compared to other agents' performance 503 is displayed. At a glance, an agent 309 can determine how he or she can improve. If desired, the agent's performance is located relative to a current threshold 505 for earning bonuses, the performance 507 of the most productive agent, etc. Chart 500 or other means of reporting or feedback for agents 309 may displayed on a computer screen and/or other visual or audio means.

In the particular example illustrated, one agent 309 is compared to all of the 25 agents in the office or facility. In summary, the performance 501 of agent 309 is below average in courtesy and calls per hour, but slightly above average in sales. In addition, performance 501 is well below that required for bonuses. The current scope or pool of agents against which a particular agent is compared can be changed by the agents so that they can compare their performance to an appropriate standard.

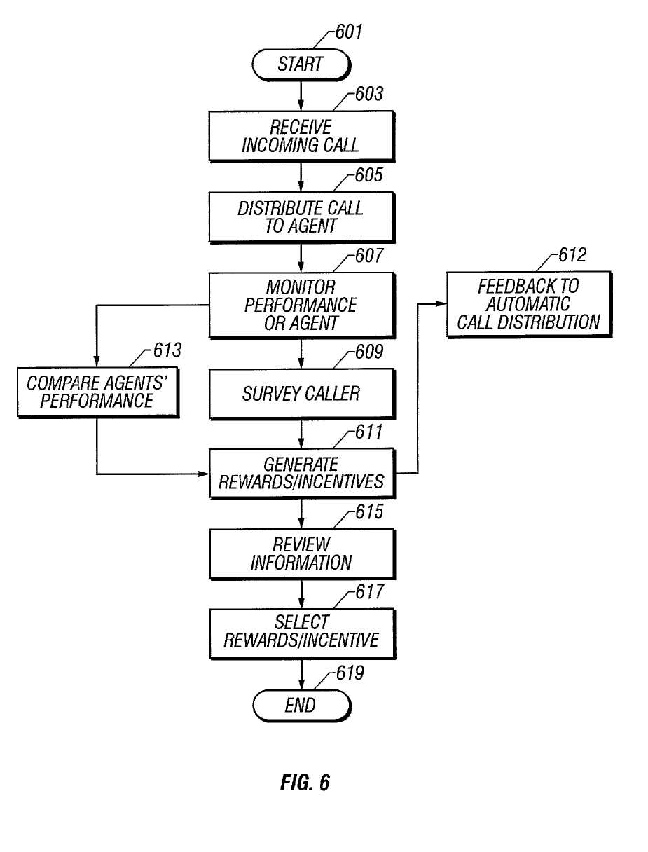

Referring now to FIG. 6, there is shown a high level, logic flow diagram of an illustrative embodiment of the method and system of the present invention. The process begins as illustrated at block 601. When an incoming call 603 (depicted at block 603) is initiated by a constituent through the public telephone system, the call is received by the call center. As illustrated at block 605, the call center automatically distributes the call to an appropriate agent based on one or more of a number of criteria, which are described above. The call center distribution system has access to the performance monitoring system, which assists in properly facilitating distribution of the incoming calls, as depicted at block 607. The performance of the agent is evaluated based on sales, the number of calls handled by the agent, etc. As illustrated at block 609, the performance of the agent is also monitored via various other mechanisms, including an automated survey of the caller. After the performance of the agent is assessed and the survey is completed by the caller, the collected data is used to generate rewards or incentives for the agent, as depicted at block 611.

As illustrated at block 613 of FIG. 6, the incentives and rewards are based on many factors including a comparison with the performance of other agents. The agent's performance, comparisons, rewards, incentives, summaries, statistics, and other data relating to the agent or other agents can then be reviewed by the agent, as depicted at block 615. As illustrated at block 617, the agent may then select one or more of the rewards offered to him or her, or take advantage of an incentive provided. The process terminates as indicated at block 619.

The present invention has several advantages. The business method and system motivates and rewards call center agents. Agent performance can be determined in part by customer responses to questions posed during or following conversations with the agent. Top performance can be rewarded by providing tangible rewards that can be monitored by the agent. The rewards include increased credits in a retirement plan, an increase in the percentage or amount of matching funds by the employer, additional time off, reduced call volumes, enabling the agent to preferentially select certain customers or types of calls, and other tangible benefits.

The method and system of the present invention also utilizes monitoring software that allows the agents to compare their performance to some desired statistic representing the performance of other agents. For example, agents can compare their performance (including real time) to the best, worst, or average performing agents in the same or other facility, state, or country, or to other agents around the world. Additional monitoring software analyzes the performance of agents based on electronic monitoring of the number of calls handled, the average as well as minimum/maximum call handling time, the number of sales per unit of time, and caller feedback. The performance monitoring system can be used at the discretion of management or directly used for agent recognition, reward, and retention.

It is also important to note that, although the present invention has been described for use in conjunction with a fully functional computer system, those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal-bearing media include, but are not limited to, recordable-type media such as floppy disks or CD-ROMs and transmission-type media such as analogue or digital communications links. Furthermore, many of the steps of the present invention may be offered and performed in a different order than the one presented above.

What is claimed is:

1. A method of automatically monitoring and rewarding the performance of support personnel in a remote service center, the method comprising:
(a) receiving a communication from a constituent;
(b) distributing the communication to an agent;
(c) monitoring a performance of the agent with respect to the communication;
(d) evaluating the performance of the agent with respect to other performances;
(e) generating at least one reward for the agent based on step (d); and
(f) presenting data to the agent regarding performances and the reward.

2. The method of claim 1 wherein step (a) comprises receiving a telephone call from the constituent.

3. The method of claim 1 wherein step (a) comprises receiving an e-mail from the constituent.

4. The method of claim 1 wherein step (c) further comprises surveying the constituent.

5. The method of claim 1 wherein step (d) comprises comparing the performance of the agent to performances of other agents.

6. The method of claim 1 wherein step (d) comprises comparing the agent to other agents at facilities other than the remote service center of the agent.

7. The method of claim 1 wherein steps (c) and (d) comprise monitoring and evaluating the agent based on sales to constituents and a number of communications handled by the agent.

8. The method of claim 1, further comprising the step of the agent selecting said at least one reward.

9. A method of automatically monitoring and rewarding the performances of agents in remote service centers, the method comprising:
(a) receiving incoming communications from constituents;
(b) automatically and selectively distributing the communications to appropriate agents;
(c) monitoring performances of the agents with respect to the communications;
(d) evaluating the performances of the agents with respect to other performances;
(e) generating rewards and incentives for the agents based on step (d); and
(f) presenting data to the agents regarding the performances and the rewards.

10. The method of claim 9 wherein step (a) comprises receiving telephone calls from the constituents.

11. The method of claim 9 wherein step (a) comprises receiving e-mails from the constituents.

12. The method of claim 9 wherein step (c) comprises surveying the constituent.

13. The method of claim 9 wherein steps (c) and (d) comprise monitoring and evaluating the agents based on sales to constituents and a number of communications handled by each of the agents.

14. The method of claim 9, further comprising the step of the agents selecting from among the rewards.

15. The method of claim 9 wherein the communications are selectively distributed to the agents based on step (e).

16. A method of automatically monitoring and rewarding the performances of agents in telephone call centers, the method comprising:
(a) receiving external incoming telephone calls from constituents;
(b) automatically and selectively distributing the telephone calls to agents;
(c) monitoring performances of the agents with respect to the telephone calls;
(d) surveying the constituents with respect to performances of the agents;
(e) evaluating the performances of the agents with respect to other performances and the surveys;
(f) generating rewards and incentives for the agents based on steps (d) and (e); and
(g) presenting data to the agents regarding the performances, the surveys, and the rewards.

17. The method of claim 16 wherein steps (c) and (e) comprise monitoring and evaluating the agents based on sales to constituents and a number of telephone calls handled by each of the agents.

18. The method of claim 16, further comprising the step of the agents selecting from among the rewards.

19. The method of claim 16 wherein the communications are selectively distributed to the agents based on step (f).
